(19) United States
(12) Patent Application Publication
(10) Pub. No.: US 2010/0041848 A1
(43) Pub. Date: Feb. 18, 2010

(54) AMPHIPHILIC POLYMER AND METHOD FOR PREPARING THE SAME

(76) Inventors: Chia-Chang Liu, Taipei City (TW); Ken-Yuan Chang, Taoyuan Hsien (TW); Fa-Chen Chi, Taoyuan Hsien (TW)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/352,274

(22) Filed: Jan. 12, 2009

Related U.S. Application Data
(63) Continuation-in-part of application No. 12/192,575, filed on Aug. 15, 2008.

(51) Int. Cl. C08F 251/00

(52) U.S. Cl. 527/312

(57) ABSTRACT

An amphiphilic polymer having the following formula (I):

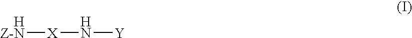

wherein Z is a hydroxyl-substituted aliphatic group having formula (Z1) or (Z2):

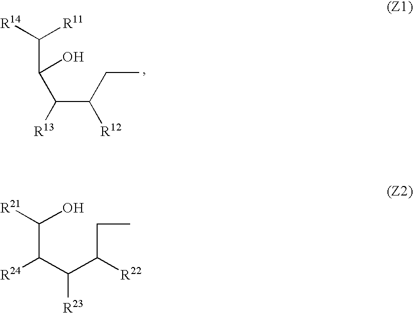

wherein R¹¹ and R²¹ are independently hydrogen, hydroxyl, hydroxymethyl, methyl, or a C₁-C₂₀ alkyl group, and R¹², R¹³, R¹⁴, R²², R²³, and R²⁴ are independently hydrogen, hydroxyl, or a sugar moiety;

X is a C₁-C₆ divalent aliphatic group; and

Y is a biodegradable group having the following formula (II):

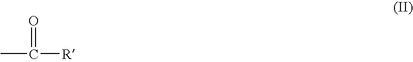

wherein R′ is a hydrocarbyl group or a polyester block having the following formula (II-A),

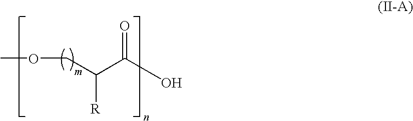

wherein, in each occurrence, R is hydrogen or a C₁-C₁₈ alkyl group, m is an integer ranging from 0 to 5, and n is an integer ranging from 10 to 300.

### CROSS-REFERENCE TO RELATED APPLICATION

This application is a continuation-in-part (CIP) of U.S. patent application Ser. No. 12/192,575, filed on Aug. 15, 2008, the entire disclosure of which is incorporated herein by reference.

### BACKGROUND OF THE INVENTION

1. Field of the Invention

This invention relates to an amphiphilic polymer, more particularly to an amphiphilic polymer, which can be used as a transdermal delivery carrier.

2. Description of the Related Art

An amphiphilic polymer is a polymer including hydrophilic and hydrophobic groups, and has been widely used in the pharmaceutical field, cosmetics field, etc.

Tatsuro Ouchi et al. discloses a method for preparing an amphiphilic polymer (Biomacromolecules 2003, 4, 477-480). Specifically, as shown in scheme 1, 2-aminoethanol was reacted with (Boc)₂O so as to form Boc-aminoethanol, in which a reactive amino end group of 2-aminoethanol was protected by a Boc group (protection step), followed by polymerization of Boc-amino ethanol with L-lactide so as to form polyLA-NHBoc. Then, the Boc group was removed from polyLA-NHBoc so as to form polyLA-NH₂ (deprotection step). As shown in scheme 2, polyLA-NH₂ thus obtained in scheme 1 was reacted with lactose (method 1) or lactonolactone (method 2) so as to form Lac-polyLA. In the process according to this literature, since protection and deprotection of the reactive amino end group of 2-aminoethanol are required, the method is complicated, thereby resulting in increased preparation costs.

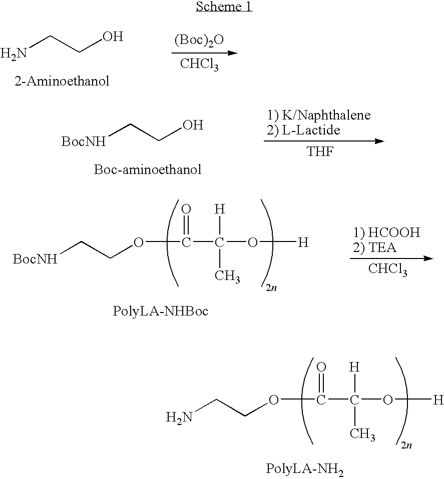

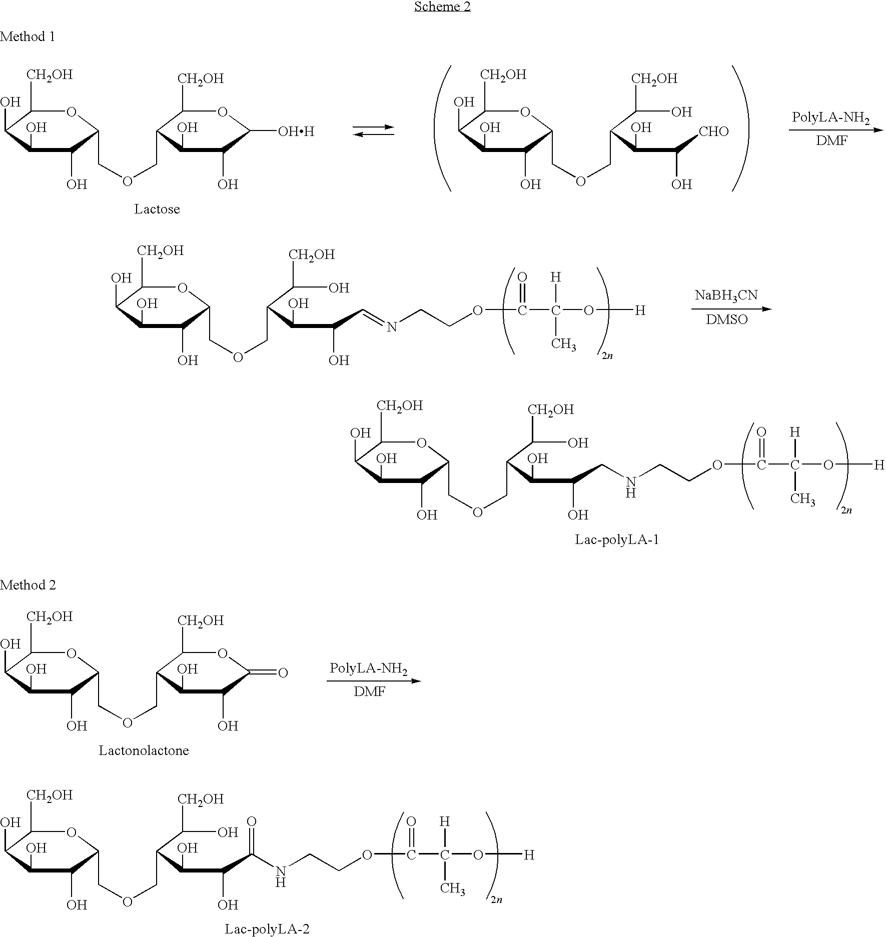

In addition, U.S. Pat. No. 5,674,830 discloses a process for manufacturing alkylglycoside esters, in which an alkylglycoside and an acyl group donor, e.g. aliphatic acid, are contacted with an enzyme catalyst. The technical feature of the patent resides in that a stable micro-emulsion is formed by mixing the reactants and surface-active material before the reactants are contacted with the enzyme catalyst and only then could the enzyme be brought to contact with the micro-emulsion. In the process of this patent, as the enzyme catalyst is additionally required, extra processing steps have to be taken to separate the enzyme catalyst from the product, thus rendering the method relatively complicated.

### SUMMARY OF THE INVENTION

Therefore, there is a need in the art to provide an amphiphilic polymer and a method for preparing the amphiphilic polymer, that can overcome the drawbacks of the aforesaid prior art.

According to one aspect of this invention an amphiphilic polymer has the following formula (I):

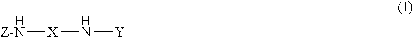

wherein Z is a hydroxyl-substituted aliphatic group having formula (Z1) or (Z2):

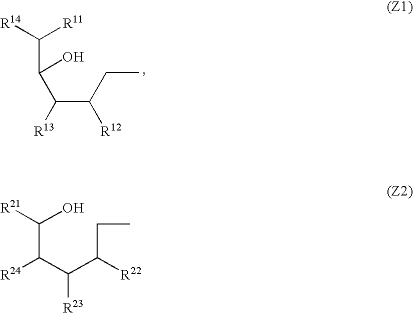

wherein R¹¹ and R²¹ are independently hydrogen, hydroxyl, hydroxymethyl, methyl, or a C₁-C₂₀ alkyl group, and R¹², R¹³, R¹⁴, R²², R²³, and R²⁴ are independently hydrogen, hydroxyl, or a sugar moiety;

X is a C₁-C₆ divalent aliphatic group; and

Y is a biodegradable group having the following formula (II):

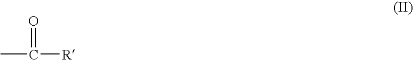

wherein R′ is a hydrocarbyl group or a polyester block having the following formula (II-A)

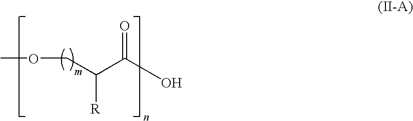

wherein, in each occurrence, R is hydrogen or a C₁-C₁₈ alkyl group, m is an integer ranging from 0 to 5, and n is an integer ranging from 10 to 300.

According to another aspect of this invention, a method for preparing the aforesaid amphiphilic polymer includes the following step:

(a) reacting a diamine compound of formula (V)

H₂N—X—NH₂ (V)

with a sugar having the following formula (III) or (IV):

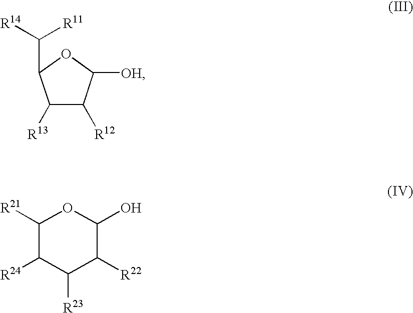

so as to form a compound having the following formula (VI):

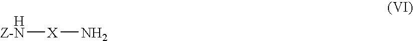

wherein, in formulae (V) and (VI), X is a C₁-C₆divalent aliphatic group, in formula (VI), Z being a hydroxyl-substituted aliphatic group having formula (Z1) or (Z2):

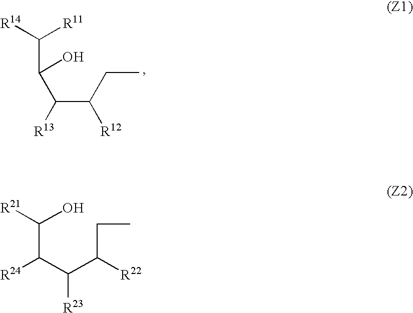

wherein R¹¹ of formulae (III) and (Z1) and R²¹ of formulae (IV) and (Z2) are independently hydrogen, hydroxyl, hydroxymethyl, methyl, or a C1-C₂₀ alkyl group, and R¹², R¹³, R¹⁴ of formulae (III) and (Z1) and R²², R²³, and R²⁴ of formulae (IV) and (Z2) are independently hydrogen, hydroxyl, or a sugar moiety; and

(b) reacting a biodegradable compound having the following formula (VII):

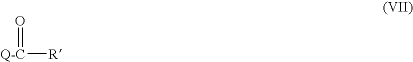

wherein Q is OH, F, Cl, Br, or I; R′ being a hydrocarbyl group or a polyester block having the following formula (II-A)

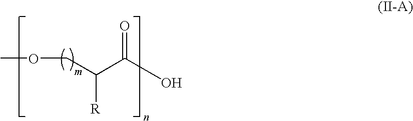

wherein, in each occurrence, R is hydrogen or a C₁-C₁₈ alkyl group; m is an integer ranging from 0 to 5, and n is an integer ranging from 10 to 300;

with the compound of formula (VI) so as to form the amphiphilic polymer.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a plot showing an FT-IR spectrum of the amphiphilic polymer of Example 1 of this invention;

FIG. 2 shows a TEM image to illustrate the micelles composed of the amphiphilic polymer of Example 1 of this invention; and

FIG. 3 shows a plot of the ratio of the fluorescence intensity (I375/I395) of pyrene versus the logarithmic value of the concentration of the amphiphilic polymer.

### DETAILED DESCRIPTION OF THE PREFERRED EMBODIMENTS

An amphiphilic polymer according to the present invention is shown to include a structure of formula (I)

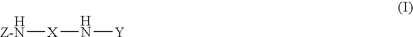

wherein Z is a hydroxyl-substituted aliphatic group having formula (Z1) or (Z2):

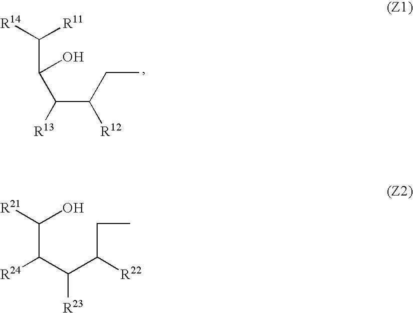

wherein R¹¹ and R²¹ are independently hydrogen, hydroxyl, hydroxymethyl, methyl, or a C₁-C₂₀ alkyl group, and R¹², R¹³, R¹⁴, R²², R²³, and R²⁴ are independently hydrogen, hydroxyl, or a sugar moiety;

X is a C₁-C₆ divalent aliphatic group; and

Y is a biodegradable group having the following formula (II):

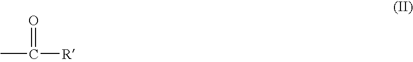

wherein R′ is a hydrocarbyl group or a polyester block having the following formula (II-A):

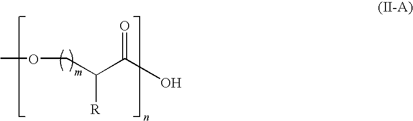

wherein, in each occurrence, R is hydrogen or a C₁-C₁₈ alkyl group, m is an integer ranging from 0 to 5, and n is an integer ranging from 10 to 300.

Preferably, R¹², R¹³, R¹⁴, R²², R²³, and R²⁴ are independently hydrogen, and R¹¹ and R²¹ are independently hydroxymethyl, hydrogen, or a methyl group.

In an embodiment of this invention, Z is a hydroxyl-substituted aliphatic group having the formula (Z2). In formula (Z2), R²¹ is a hydroxymethyl group; R²² and R²³ are independently a hydroxyl group; and R²⁴ is

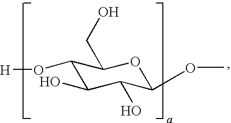

wherein a is an integer ranging from 1 to 9. Preferably, a is 1.

In this invention, Z can be a hydroxyl-substituted aliphatic group having the formula (Z2). In formula (Z2), R²¹ is

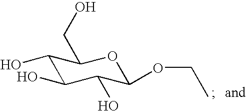

R²², R²³, and R²⁴ are independently a hydroxyl group. In addition, Z can be a hydroxyl-substituted aliphatic group having the formula (Z2). In formula (Z2), R²¹ is hydroxymethyl, R²² and R²³ are independently a hydroxyl group, and R²⁴ is

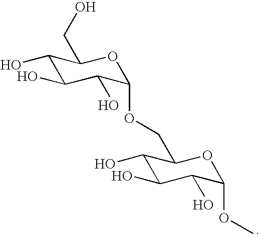

In formula (I), preferably, X is a C₁-C₆ alkylene group. More preferably, X is an ethylene group.

Preferably, the biodegradable group (Y) is derived from a biodegradable polyester, an aliphatic acid, and derivatives of an aliphatic acid.

Preferably, when Y is derived from the aliphatic acid, R′ in formula (II) is a C₃-C₂₇ alkyl group or a C₁₃-C₂₁ alkylene group, more preferably, is a C₃-C₂₃ alkyl group, and most preferably, is a C₇-C₂₃ alkyl group.

Preferably, examples of the aliphatic acid and derivates thereof include decanoyl chloride, lauroyl chloride, palmitoyl chloride, decanoic acid, lauric acid, palmitic acid, and oleic acid.

Preferably, when Y is derived from the biodegradable polyester (i.e., formula (II-A)), R is a methyl group or a hydrogen group, m is an integer ranging from 0 to 4, and n is an integer ranging from 10 to 200.

Preferably, examples of the aforesaid biodegradable polyester include, but are not limited to, poly(lactic acid), poly(glycolic acid), poly(hydroxy butyrate), polycaprolactone, poly(hydroxy valerate), or combinations thereof. More preferably, the biodegradable polyester is poly(lactic acid), polycaprolactone, or combinations thereof.

Preferably, the biodegradable polyester has a molecular weight ranging from 500 to 25,000, more preferably from 500 to 13,000, and most preferably from 1000 to 10,000.

A method for preparing the aforesaid amphiphilic polymer includes the following step:

(a) reacting a diamine compound of formula (V)

H₂N—X—NH₂ (V)

with a sugar having formula (III) or (IV):

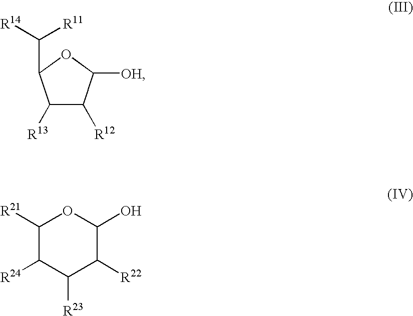

so as to form a compound having formula (VI):

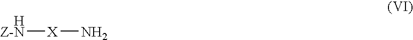

wherein, in formulae (V) and (VI), X is a C₁-C₆divalent aliphatic group; Z being a hydroxyl-substituted aliphatic group having formula (Z1) or (Z2):

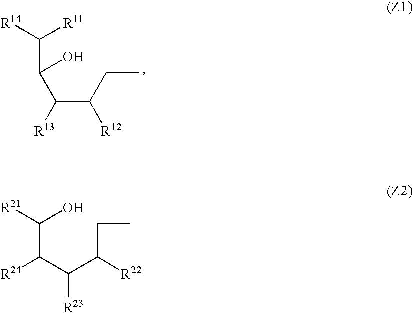

wherein R¹¹, R¹² R¹³, R¹⁴ of formulae (III) and (Z1), and R²¹, R²², R²³, and R²⁴ of formulae (IV) and (Z2) are as defined above;

(b) reacting a biodegradable compound having the following formula (VII)

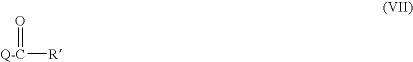

wherein Q is OH, F, Cl, Br, or I; and R′ is a hydrocarbyl group as defined above or a polyester block having the following formula (II-A)

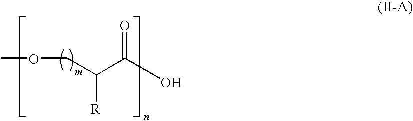

wherein R, m, and n are as defined above; with the compound having formula (VI) so as to form the amphiphilic polymer.

Preferably, Q is OH or Cl.

Before step (b), when Q in the formula (VII) is OH, the method further includes a step of activating the biodegradable compound using an activator in the presence of a solvent. Examples of the activator include N,N′-dicyclohexylcarbodiimide (DCC), N,N′-diisopropylcarbodiimide (DIC), 1-ethyl-3-(3-dimethylaminopropyl) carbodiimide hydrochloride, and combinations thereof. Examples of the solvent include dimethyl sulfoxide (DMSO), dimethylformamide (DMF), dimethylacetamide (DMAC), and combinations thereof.

Moreover, in step (a), in addition to the compound of formula (VI), a compound having the following formula (VI′) and carrying positive charge might be produced.

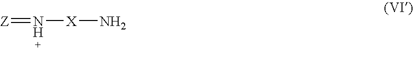

In formula (VI′), Z and X are as defined in formula (VI). To enhance the productivity of the amphiphilic polymer, step (a) is preferably conducted in the presence of a reducing agent so as to reduce formula (VI′) to formula (VI). Alternatively, formula (VI′) can be reduced to formula (VI) under hydrogen atmosphere by high-pressure hydrogenation reaction.

Preferably, examples of the reducing agent include sodium borohydride (NaBH₄), sodium cyano borohydride (NaBH₃CN), and the combination thereof. Preferably, the sugar of formula (III) or (IV) has a molecular weight ranging from 180 to 20,000, more preferably from 300 to 10,000, and most preferably from 300 to 7,000. Examples of the sugars include D-glucose, D-mannose, D-galactose, D-talose, D-gulose, D-idose, D-allose, D-altrose, L-idose, L-gulose, L-glucose, D-ribose, D-arabinose, D-xylose, D-lyxose, L-fucose, L-rhamnose, L-fucose, D-rhamnose, cellobiose, maltose, lactose, glucan, galactobiose, maltotriose, maltotetraose, panose, gentiobiose, isomaltose, melibiose, etc.

### EXAMPLES

### Preparation of Amphiphilic Polymer

### Example 1

102.6 g Lactose (Mw. 342) and 18 g ethylenediamine were respectively dissolved in 300 ml and 10 ml of de-ionized water at ambient temperature so as to form a lactose solution and an ethylenediamine solution, respectively. The lactose solution was added dropwise into the ethylenediamine solution, followed by stirring for 4 hours, so as to form a reaction solution having a compound of formula (p3) and a compound of formula (p3′).

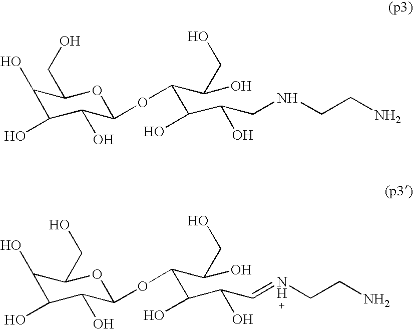

In an ice bath, the reaction solution was added with 12.5 g sodium borohydride, and was stirred for 1 day, such that the compound of formula (p3′) in the reaction solution was reduced to the compound of formula (p3). After water was removed from the reaction solution, the compound of formula (p3) was purified using an acetone/methanol solution. The purified compound (p3) was identified using nuclear magnetic resonance spectroscopy (NMR, ADVANCED 300, commercially available from BRUKER). ¹H(300 MHz, D₂O): δ 4.38 (d, J=7.0 Hz, H1 of galactose), 4.19˜4.04 (m, 1H, sugar), 3.89˜3.83 (m, 1H, sugar), 3.77˜3.52 (m, 9H, sugar), 3.48˜3.33(m, 1H, sugar), 3.19˜3.03(m, 4H, CH₂N), 2.98˜2.83(m, 2H, CH₂N).

20 g of poly(lactic acid) having an average molecular weight of 3200 was dissolved in dimethyl sulfoxide (the concentration is about 0.5 g/ml), followed by activation using 1.5 g of N,N′-dicyclohexylcarbodiimide (an activator) for 4 hours. 2.5 g of the aforesaid purified compound (p3) was reacted with the activated poly(lactic acid) for 4 to 8 hours, followed by a purification step using a dialysis membrane, so as to form a polymer. The polymer thus formed was identified using NMR, Fourier Transform Infrared (FT-IR), and transmission electron microscopy (TEM).

The result determined by NMR is as follows:

¹H (300 MHz, D⁶-DMSO): δ 5.55(d, J=5.8 Hz, 1H, H1 of lactose), 5.17(Quartet, J=5.3 Hz, CH of PLA), 3.8˜2.7(m, 18H, sugar, NCH₂—CH₂N), 1.6(d, J=5.3 Hz, CH₃ of PLA).

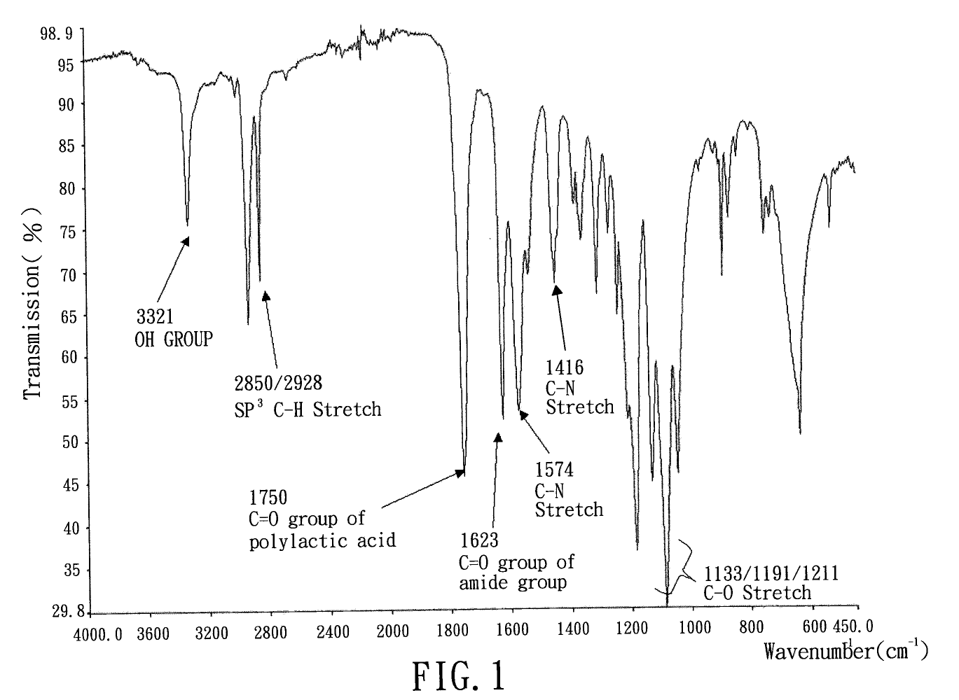

The results determined by FT-IR (see FIG. 1) and NMR indicate the polymer to be an amphiphilic polymer having the following formula (A):

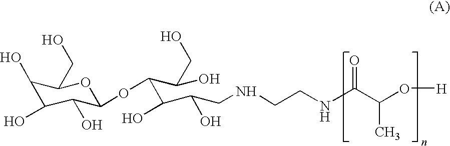

in which n is an integer ranging from 30 to 50.

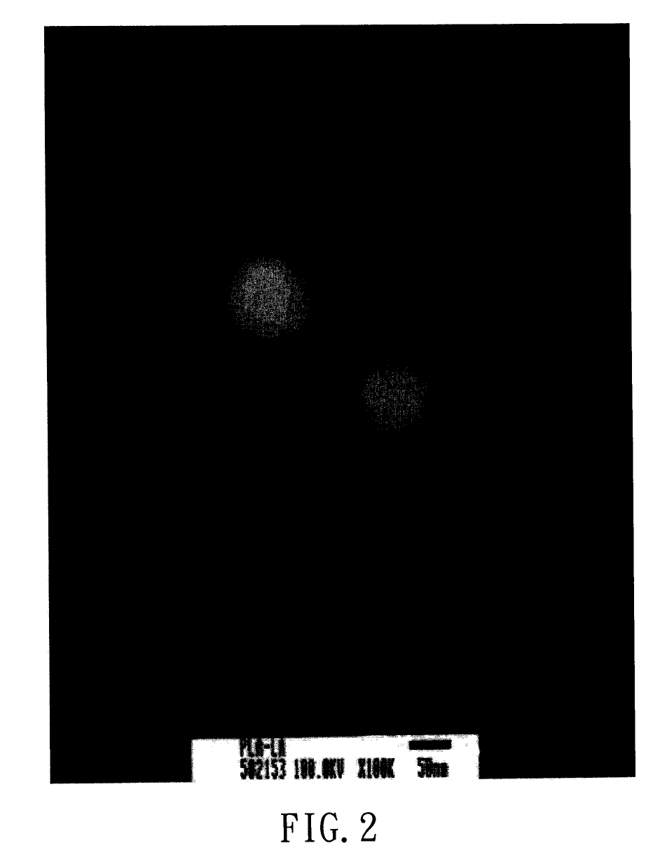

For TEM observation, a colloid solution prepared by dispensing the amphiphilic polymer of formula (A) in water was deposited on a copper grid and was dried, followed by a negative staining procedure using 20 μl of 2% potassium phosphotungstate for 5 to 10 minutes. The result shown in FIG. 2 indicates formation of micelles of the amphiphilic polymer according to this invention.

### Example 2

The method for preparing an amphiphilic polymer in this example was similar to that of the previous example except that the poly(lactic acid) in Example 2 has an average molecular weight of 5600.

### Example 3

50 g Glucan (Mw. 15000-20000) and 2 g ethylenediamine were respectively dissolved in 300 ml and 10 ml of de-ionized water at ambient temperature so as to form a glucan solution and an ethylenediamine solution, respectively. The glucan solution was added dropwise into the ethylenediamine solution, followed by stirring for 4 hours, so as to form a reaction solution. In an ice bath, the reaction solution was added with 1.2 g sodium borohydride, and was stirred for 1 day. The desired compound was obtained after purification.

5 g of polycaprolactone having an average molecular weight of 17,000 was dissolved in dimethyl sulfoxide (the concentration is about 0.1 g/ml), followed by activation using 0.3 g of N,N′-dicyclohexylcarbodiimide (an activator) for 9 hours. 5 g of the aforesaid purified compound was reacted with the activated polycaprolactone for 4 to 8 hours, followed by a purification step using dichloromethane and methanol, so as to form an amphiphilic polymer having formula (B):

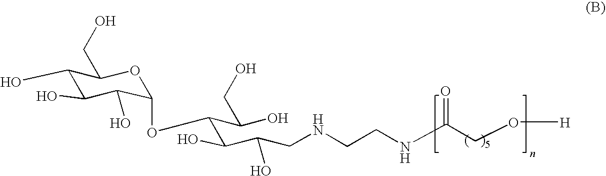

in which n is an integer ranging from 130 to 150.

### Example 4

50 g Lactose (Mw. 342) and 50 g ethylenediamine were respectively dissolved in 300 ml and 10 ml of de-ionized water at ambient temperature so as to form a lactose solution and an ethylenediamine solution, respectively. The lactose solution was added dropwise into the ethylenediamine solution, followed by stirring for 4 hours, so as to form a reaction solution. In an ice bath, the reaction solution was added with 10 g sodium borohydride, and was stirred for 1 day. The desired compound was obtained after purification.

50 g of the aforesaid purified compound was dispersed in 100ml de-ionized water (the concentration is about 0.5 g/ml), followed by reaction with 3 g lauroyl chloride for 4 to 8 hours. After the un-reacted lauroyl chloride was removed using ethyl ether, a purified polymer having the following formula (C) was obtained.

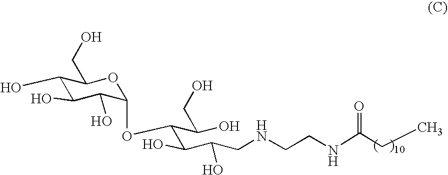

The polymer thus formed was identified using Fourier Transform Infrared (FT-IR), and the result shows that C—O stretch peaks were observed at about 1150 cm⁻¹, 1193 cm⁻¹, and 1215 cm⁻¹, C—N stretch peak for the amide group was observed at about 1416 cm⁻¹, C—N stretch peak for lactose-NH linkage was observed at about 1575 cm⁻¹, C═O absorbance peak for the amide group was observed at about 1635 cm⁻¹, SP³ C—H stretch peaks were observed at about 2853 cm⁻¹ and 2932 cm⁻¹, and OH absorbance peak was observed at about 3321 cm⁻¹.

### Example 5

The method for preparing an amphiphilic polymer in this example was similar to that of Example 4 except that 2.6 g of decanoyl chloride was used instead of lauroyl chloride. The polymer thus formed has the following formula (D).

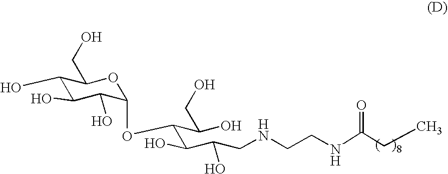

### Example 6

The method for preparing an amphiphilic polymer in this example was similar to that of Example 4 except that 3.8 g of palmitoyl chloride was used instead of lauroyl chloride. The polymer thus formed has the following formula (E).

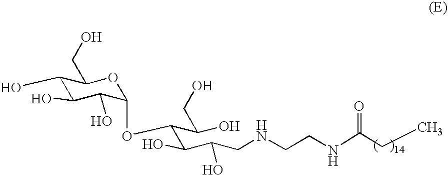

### Example 7

50 g Lactose (Mw. 342) and 50 g ethylenediamine were respectively dissolved in 300 ml and 10 ml of de-ionized water at ambient temperature so as to form a lactose solution and an ethylenediamine solution, respectively. The lactose solution was added dropwise into the ethylenediamine solution, followed by stirring for 4 hours, so as to form a reaction solution. In an ice bath, the reaction solution was added with 10 g sodium borohydride, and was stirred for 1 day. The desired compound was obtained after purification.

5 g of oleic acid was dissolved in 200 ml of tetrahydrofuran, followed by activation using N,N′-dicyclohexylcarbodiimide for 9 hours. 6.4 g of the aforesaid purified compound was added into and reacted with the activated oleic acid for 4 to 8 hours, followed by a purification step using methanol so as to form an amphiphilic polymer having the following formula (F).

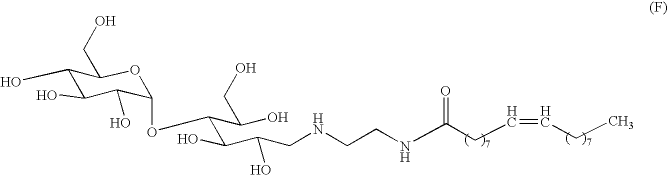

The polymer thus formed was identified using Fourier Transform Infrared (FT-IR), and the result shows that C-O stretch peaks were observed at about 1159 cm⁻¹, 1186 cm⁻¹, and 1229 cm⁻¹, C—N stretch peak for the amide group was observed at about 1420 cm⁻¹, C═C stretch peak for the oleic acid was observed at about 1436 cm⁻¹, C—N stretch peak for lactose-NH linkage was observed at about 1569 cm⁻¹, C═O absorbance peak for the amide group was observed at about 1621 cm⁻¹, SP³ C-H stretch peaks were observed at about 2850 cm⁻¹ and 2926 cm⁻¹, and OH absorbance peak was observed at about 3323 cm⁻¹.

### Measurement of Critical Micelle Concentration

The micellization of the amphiphilic polymer in aqueous solution depends on the concentration thereof. To determine the critical micelle concentration for each of the amphiphilic polymers thus obtained, pyrene was used as a fluorescence probe, and the amphiphilic polymer solutions with different concentrations, i.e., 10⁻¹ mg/ml, 10⁻² mg/ml, 10⁻³ mg/ml, 10⁻⁴ mg/ml and 10⁻⁵ mg/ml were prepared. The amphiphilic polymer solutions thus obtained were mixed with 6×10⁻⁷ M of pyrene solution, followed by ultra-sonication for 15 minutes and standing for 24 hours. The critical micelle concentration for each of the amphiphilic polymers was determined by fluorescence emitted from pyrene using a spectrofluorophotometer (Hitachi Model 4500). The excitation spectra were recorded from 350 nm to 400 nm with the emission wavelength at 339 nm. The fluorescence intensity ratio of I375 to I395 was plotted against the concentration of the respective amphiphilic polymer.

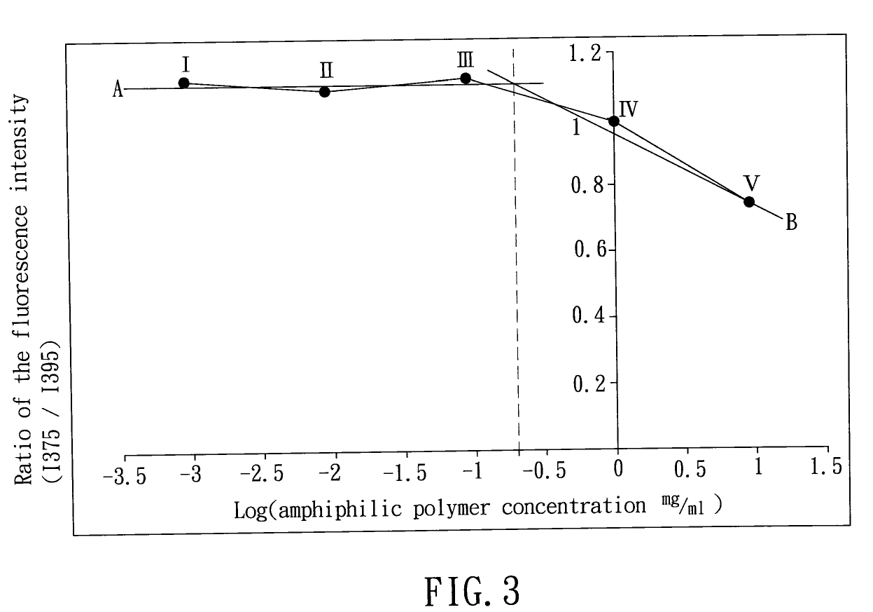

FIG. 3 shows a plot of the ratio of the fluorescence intensity (I375/I395) of pyrene versus the logarithmic value of the concentration of the lauroyl chloride/lactose amphiphilic polymer of Example 4. Referring to FIG. 3, Line A was plotted based on points I, II, and III, and Line B was plotted based on points III, IV, and V. The intersection point of Lines A and B indicated the logarithmic value of the critical micelle concentration for the amphiphilic polymer of Example 4, and the concentration thus measured was about 0.2 mg/ml. Similarly, the critical micelle concentrations for the amphiphilic polymers of Examples 1, 2, 5, and 6 were 0.04 mg/ml, 0.003 mg/ml, 1.5 mg/ml, and 0.1 mg/ml, respectively. Concluded from the aforesaid data, it is manifested that the amphiphilic polymers of this invention can be used to form micelles.

### Test Methods

To determine the penetration ability of the amphiphilic polymers thus obtained, micelles composed of the amphiphilic polymers of the invention and encapsulating a desired substance to be delivered into skin were prepared (see Experiments). The micelles thus obtained were subjected to loading content and skin penetration tests. Loading content refers to the percentage of weight of the desired substance based on the total weight of the micelles. The skin penetration test was carried out according to the disclosure in Journal of Pharmaceutical and biomedical Analysis, 40(2006): 1187-1197. In this invention, partial thickness skin (including epidermis and partial dermis) of pigs and Franz diffusion cell with 0.785 cm² penetration area were used, and the test was conducted at 37±0.2° C. for 24 hrs.

### Preparation of Micelles

### Experiment 1

Into a 0.1 wt % amphiphilic polymer suspension prepared by dispensing the amphiphilic polymer of Example 1 in deionized water, ellagic acid dissolved in ethanol was slowly added so as to form a mixture solution, in which the weight ratio of ellagic acid to the amphiphilic polymer is 1:9. The mixture solution was subjected to ultra-sonication for 15 minutes, followed by a dialysis procedure, so that micelles encapsulating ellagic acid were gradually formed. The micelles were dried using a freeze dryer, followed by determination of the loading content thereof. For the skin penetration test, a test solution having 1.2 mg/ml micelle concentration was prepared by dissolving the micelles in deionized water. The loading content and the skin penetration rate of the micelles of Experiment 1 are shown in Tables 1 and 2, respectively.

### Experiment 2

The micelles prepared in Experiment 2 were similar to those of Experiment 1 except that the amphiphilic polymer used in Experiment 2 was prepared using the method of Example 2. The loading content of the micelles is shown in Table 1.

### Experiment 3

The micelles prepared in Experiment 3 were similar to those of Experiment 1 except that the amphiphilic polymer used in this Experiment was prepared using the method of Example 3. The loading content and the skin penetration rate of the micelles are shown in Tables 1 and 2.

### Experiment 4

Into a 0.1 wt % amphiphilic polymer suspension prepared by dispensing the amphiphilic polymer of Example 1 in acetone, arbutin dissolved in deionized water was slowly added so as to form a mixture solution, in which the weight ratio of arbutin to the amphiphilic polymer is 1:20. The mixture solution was mixed using a homogenizer at 10,000 rpm for 5 minutes, and was subsequently evaporated to remove acetone using an evaporator, thereby forming arbutin-encapsulating micelles. The loading content of the micelles thus formed is shown in Table 1.

### Experiment 5

The amphiphilic polymer of Example 4 and CoQ10 at a weight ratio of 10:1 were uniformly dispersed in tetrahydrofuran so as to form a suspension. The suspension was mixed using a homogenizer at 10,000 rpm for 5 minutes after adding thereto an appropriate amount of de-ionized water. The tetrahydrofuran in the suspension was removed using an evaporator, thereby forming 10 mg/ml CoQ10-encapsulating micelles. The loading content of the micelles thus formed is shown in Table 1.

### Experiment 6

The micelles prepared in Experiment 6 were similar to those of Experiment 5 except that the amphiphilic polymer used in Experiment 6 was prepared using the method of Example 6. The loading content of the micelles is shown in Tables 1.

### Comparative Experiment 1

### Preparation of Micelles

The micelles prepared in Comparative Experiment 1 were similar to those of Experiment 1 except that the amphiphilic polymer used here was a conventional amphiphilic polymer made from poly(lactic acid) having a molecular weight of 4200 and polyethylene glycol. The loading content and the skin penetration rate are shown in Tables 1 and 2.

### Comparative Experiment 2

### Preparation of an Ellagic Acid Solution

An ellagic acid solution was prepared by diluting 72 μl of 1 mg/ml ellagic acid solution (dissolved in ethanol) with deionized water to a total volume of 1 ml. The skin penetration rate is shown in Table 2.

TABLE 1

| | Expt. | | | | | | Comp. |
|---|---|---|---|---|---|---|---|
| | 1 | Expt. 2 | Expt. 3 | Expt. 4 | Expt. 5 | Expt. 6 | Expt. 1 |
| Loading | 6.23 | 6.29 | 3.81 | 2.71 | 9.6 | 6.4 | 3.75 |
| content | | | | | | | |
| (wt %) | | | | | | | |

TABLE 2

| | | | Comparative | |
|---|---|---|---|---|
| | Experiment | Experiment | Experiment | Comparative |
| | 1 | 3 | 1 | Experiment 2 |
| Skin | 12.17 | 10.36 | 11.50 | 8.83 |
| penetration | | | | |
| rate (%) | | | | |

Note that, in Table 1, the micelles of Experiments 1 to 3, 5 and 6 exhibit superior loading content over that of Comparative Experiment 1. In addition, in Table 2, compared with the ellagic acid solution of Comparative Experiment 2, the micelles composed of the amphiphilic polymer of this invention and encapsulating ellagic acid exhibit a superior skin penetration rate, about 37.8% ((12.17−8.83)/8.83) improvement for Experiment 1. Moreover, the micelles of Experiment 1 exhibit higher skin penetration rate than those of the Comparative Experiment 1, which were formed from the conventional amphiphilic polymer.

It should be noted, although ellagic acid and arbutin are used as an encapsulated substance in the embodiments of this invention, any suitable substance, e.g., cosmetics, drug, or food, may be used. Examples of such substance include CoQ10, vitamins (e.g., vitamins A, D, and E), amphotericin B, paclitaxol, adriamycin, etc.

With this invention, a novel amphiphilic polymer is provided as a carrier, which can efficiently encapsulate a desired substance and deliver the substance into skin. In addition, in the method for preparing the amphiphilic polymer according to this invention, since the diamine compound is used to connect the biodegradable polyester block and the sugar, the protection and deprotection steps required in the prior art can be eliminated. In addition, in the method of this invention, when the reactants are aliphatic acid and the diamine compound, no catalytic enzyme is required. Therefore, the preparation procedure of this invention is simplified, and manufacturing costs can be reduced to the minimum.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. An amphiphilic polymer having the following formula (I): 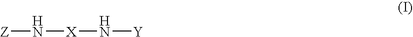
wherein Z is a hydroxyl-substituted aliphatic group having formula (Z1) or (Z2): 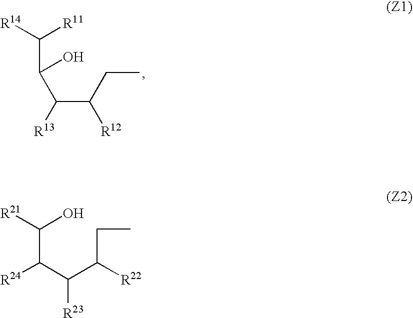
wherein R¹¹ and R²¹ are independently hydrogen, hydroxyl, hydroxymethyl, methyl, or a C₁-C₂₀ alkyl group, and R¹², R¹³, R¹⁴, R²², R²³, and R²⁴ are independently hydrogen, hydroxyl, or a sugar moiety;
X is a C₁-C₆ divalent aliphatic group; and
Y is a biodegradable group having the following formula (II): 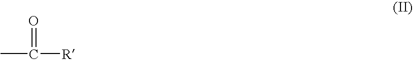
wherein R′ is a hydrocarbyl group or a polyester block having the following formula (II-A) 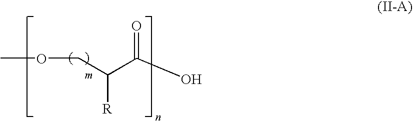
wherein, in each occurrence, R is hydrogen or a C₁-C₁₈ alkyl group, m is an integer ranging from 0 to 5, and n is an integer ranging from 10 to 300.

2. The amphiphilic polymer of claim 1, wherein R¹², R¹³, R¹⁴, R²², R²³, and R²⁴ are independently hydrogen.

3. The amphiphilic polymer of claim 2, wherein R¹ and R²¹ are independently a hydroxymethyl, hydrogen, or methyl group.

4. The amphiphilic polymer of claim 3, wherein Z is a hydroxyl-substituted aliphatic group having the formula (Z2), and, in formula (Z2), R²¹ is a hydroxymethyl group; R²² and R²³ are independently a hydroxyl group; and R²⁴ is 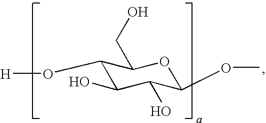
wherein a of R²⁴ is an integer ranging from 1 to 9.

5. The amphiphilic polymer of claim 1, wherein X is a C₁-C₆ alkylene group.

6. The amphiphilic polymer of claim 1, wherein said biodegradable group is derived from one selected from the group consisting of biodegradable polyester, an aliphatic acid, and derivatives of an aliphatic acid.

7. The amphiphilic polymer of claim 6, wherein said biodegradable group is derived from one selected from the group consisting of poly(lactic acid), poly(glycolic acid), poly(hydroxy butyrate), polycaprolactone, poly(hydroxy valerate), and combinations thereof.

8. The amphiphilic polymer of claim 7, wherein said biodegradable group is derived from one selected from the group consisting of poly(lactic acid), polycaprolactone, and combinations thereof.

9. The amphiphilic polymer of claim 1, wherein R of formula (II-A) is a methyl group or a hydrogen group, m is an integer ranging from 0 to 4, and n is an integer ranging from 10 to 200.

10. The amphiphilic polymer of claim 1, wherein R′ is a C₃-C₂₇ alkyl group or a C₁₃-C₂₁ alkylene group.

11. The amphiphilic polymer of claim 10, wherein said biodegradable group is derived from one selected from the group consisting of decanoyl chloride, lauroyl chloride, palmitoyl chloride, decanoic acid, lauric acid, palmitic acid, and oleic acid.

12. A method for preparing an amphiphilic polymer of claim 1, comprising the following steps:
(a) reacting a diamine compound of formula (V):
H₂N—X—NH₂ (V)
with a sugar having formula (III) or (IV): 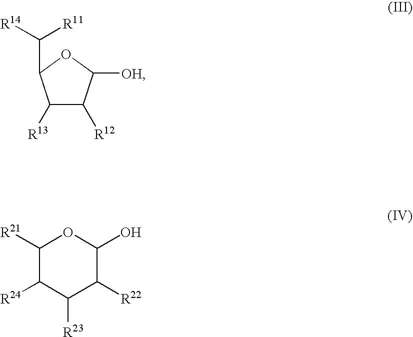
so as to form a compound having formula (VI), 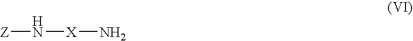
wherein, in formulae (V) and (VI), X is a C₁-C₆divalent aliphatic group; Z being a hydroxyl-substituted aliphatic group having formula (Z1) or (Z2): 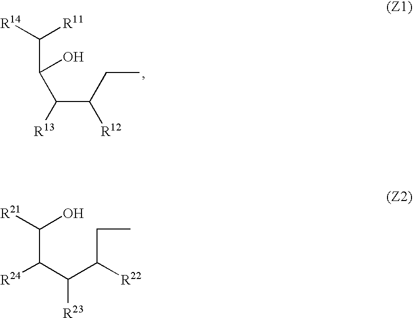
wherein R¹¹ of formulae (III) and (Z1) and R²¹ of formulae (IV) and (Z2) are independently hydrogen, hydroxyl, hydroxymethyl, methyl, or a C₁-C₂₀ alkyl group, and R¹², R¹³, R¹⁴ of formulae (III) and (Z1) and R²², R²³, and R²⁴ of formulae (IV) and (Z2) are independently hydrogen, hydroxyl, or a sugar moiety; and
(b) reacting a biodegradable compound having the following formula (VII) 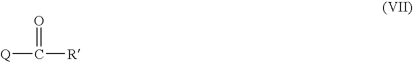
wherein Q is OH, F, Cl, Br, or I; R′ being a hydrocarbyl group or a polyester block having the following formula (II-A) 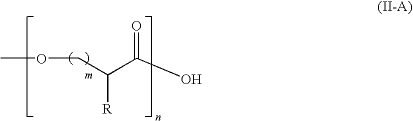
wherein, in each occurrence, R is hydrogen or a C₁-C₁₈ alkyl group; m is an integer ranging from 0 to 5, and n is an integer ranging from 10 to 300;
with the compound of formula (VI) so as to form the amphiphilic polymer.

13. The method of claim 12, wherein the step (a) is conducted in the presence of a reducing agent, the reducing agent being selected from the group consisting of sodium borohydride, sodium cyano borohydride, and the combination thereof.

14. The method of claim 12, further comprising, when Q in the formula (VII) is OH, before step (b), a step of activating the biodegradable material using an activator in the presence of a solvent, the activator being selected from the group consisting of N,N′-dicyclohexylcarbodiimide, N,N′-diisopropylcarbodiimide, 1-ethyl-3-(3-dimethylaminopropyl)carbodiimide hydrochloride, and combinations thereof, the solvent being selected from the group consisting of dimethyl sulfoxide, dimethylformamide, dimethylacetamide, and combinations thereof.

15. The method of claim 12, wherein the sugar of formula (III) or (IV) has a molecular weight ranging from 180 to 20,000.

16. The method of claim 15, wherein, when R′ of formula (VII) is the polyester block of formula (II-A), the biodegradable material has a molecular weight ranging from 500 to 25,000.

17. The method of claim 12, wherein, in the formula (VII), R′ is a C₃-C₂₇ hydrocarbyl group.
